(19) United States
(12) Patent Application Publication
(10) Pub. No.: US 2015/0069721 A1
(43) Pub. Date: Mar. 12, 2015

(54) METAL GASKET

(71) Applicant: NICHIAS CORPORATION, Tokyo (JP)

(72) Inventors: Hiroyasu Okafuji, Tokyo (JP); Naoya Kuzawa, Tokyo (JP); Hideaki Mori, Tokyo (JP); Kojiro Otani, Tokyo (JP)

(21) Appl. No.: 14/391,854

(22) PCT Filed: Apr. 2, 2013
(86) PCT No.: PCT/JP2013/002279

§ 371 Date: Oct. 10, 2014

(30) Foreign Application Priority Data
Apr. 12, 2012 (JP) 2012-091196

(51) Int. Cl. F16J 15/08

(52) U.S. Cl. CPC F16J 15/08
USPC 277/626

(57) ABSTRACT

A metal gasket 10 is provided with a columnar part 11 formed in a cylindrical shape; a beam part 12 that extends in a radial direction over the entire outer peripheral surface of the columnar part 11; and a circumferential groove 13 formed in the middle of a peripheral surface of the beam part 12; wherein the first sealing part 111 and the third sealing part 112 are formed as protruded parts, the second sealing part 122 is formed by deformation of a disk part 121 on one end side and the fourth sealing part 124 is formed by deformation of a disk part 123 on the other end side.

### TECHNICAL FIELD

The present invention relates to a metal gasket. In particular, the present invention relates to a metal gasket used in order to prevent leakage of a fluid in an ultrahigh vacuum device used in a semiconductor production device, a nuclear investment or the like.

### BACKGROUND ART

Conventionally, in a semiconductor production device, various metal gaskets are used in order to obtain a high degree of air-tightness.

For example, a metal hollow O-ring gasket is produced by forming a metal pipe such as stainless steel or Inconel into a ring-like form by bending or the like, and the both ends of the pipe are welded with each other. In this metal hollow O-ring gasket, sealing is conducted by deforming the metal ring by applying a strong clamping pressure.

However, as mentioned above, the above-mentioned metal hollow O-ring gasket is produced by welding the both ends of a metal pipe that has been bent in the form of a ring. Therefore, normally, burrs generated at the time of welding remain in the inside and outside of the pipe. By removing the burrs in the outside of the pipe by cutting, polishing or the like, the wall thickness of the pipe is slightly decreased. As a result, when clamped, the compression strength of the welded part and other parts may become un-uniform.

Accordingly, when used in applications where ultrahigh vacuum is required, leakage may occur from the welded part having a reduced wall thickness.

Further, various metal gaskets have been used in a gas supply line in a semiconductor manufacturing device. In order to allow the gas supply line to be compact, there has been a move for standardizing it as an integrated gas system in an SEMI (Semiconductor Equipment and Materials International). As for the properties of the gasket used in this integrated gas system, the gasket is required to be capable of maintaining a ultrahigh vacuum degree of 1×10⁻¹¹ Pa·m³/sec He or less and is required to be capable of conducting sealing if it is changed 20 times or more in the same flange.

In this integrated gas system, a metal gasket is inserted into various components such as a flange, a valve, a filter or the like that constitute a gas supply channel and fixed by means of a bolt. Since the diameter of the bolt is small, a large force cannot be applied to the bolt. Therefore, for a metal gasket, a decrease in clamping force required for sealing is demanded.

In order to respond to the above-mentioned requirement or demand, various technologies have been proposed.

For example, in Patent Document 1, a technology of a metal seal is disclosed. In this technology, the metal seal is provided with a first annular beam part having a first non-sealing surface and a first protruded part with a first annular sealing surface facing in a first axial direction to contact a first member for creating a first annular sealing dam therebetween; a second annular beam part having a second non-sealing surface and a second protruded part with a second annular sealing surface facing in a second axial direction, which is opposite to the first axial direction, to contact a second member for creating a second annular sealing dam therebetween; an annular inner surface extending between the first and second sealing surfaces to form a central passageway; an annular outer surface extending between the first and second sealing surfaces and spaced from the annular inner surface to form an annular columnar part of a material extending substantially perpendicular to the first and second annular beam parts therebetween; and one of the annular inner and outer surfaces has an annular recessed part extending in a substantially radial direction to at least partly define an effective minimum width of the annular columnar part.

Patent Document 2 discloses a technology of a metal gasket in which, in an annular metal gasket having a lateral U-shaped cross-sectional shape (i.e. having an opening on the outer peripheral side), at least one annular protrusion having a trapezoidal cross-sectional shape is formed on the circumferential direction on the two flat sealing surfaces that contact the mating surface, and the center of the crest of the annular protrusion is positioned within a range of a thickness t₀ of the center of the gasket.

Further, in Patent Document 3, in an annular metal gasket having a lateral U-shaped or C-shaped cross section (i.e. having an opening on the outer peripheral side), an annular space having a width of 40% or more of the wall thickness t₀ of the center of the gasket and a height H of 5% or more of the gasket height is provided on the innermost part of the circumferential direction of the two flat sealing surfaces that contact the mating surface, and the cross-section of the space is formed in the shape of a tuning fork.

Patent Document 4 discloses a metal static sealing member formed of an annular body provided with a bead, and first and second wing parts extending orthogonally with respect to the seal member axis and laterally connected to the bead, the shape of a lateral cross section along the axis of the sealing member is “V”, and the tapered surfaces of the branches of the “V” to which they are attached are slightly inclined with respect to the planar surfaces of the bead being orthogonal to the steal member axis.

### RELATED ART DOCUMENTS

### Patent Documents

Patent Document 1: JP-A-2001-355731

Patent Document 2: JP-A-2003-194225

Patent Document 3: JP-A-2004-301159

Patent Document 4: JP-A-S64-500137

### SUMMARY OF THE INVENTION

However, in the technologies in the above-mentioned Patent Documents 1, 2 and 3, since only one sealing part is provided in correspondence with each sealing surface, an improvement in reliability in sealing or the like has been desired.

As for the technology of Patent Document 4, although two or more sealing parts are provided in correspondence with each sealing surface, as mentioned above, use of the sealing material in a gas-supply line in a semiconductor production device or satisfying the requirements as the property of the gasket used in this integrated gas system still has room for improvement.

Further, in the metal gasket, further improvement in sealing performance or reduction in clamping force required for sealing has been demanded.

The present invention has been made taking the above into consideration, and is aimed at providing a metal gasket that can improve entire sealing performance or reliability of sealing, and can reduce a clamping force required for sealing.

In order to attain the object, the metal gasket of the present invention comprises: a columnar part formed in a cylindrical shape; a beam part that extends in a radial direction over the entire outer peripheral surface of the columnar part; and a circumferential groove formed in the middle of a peripheral surface of the beam part; wherein

the columnar part and the beam part are formed deformably;

on a first surface that is formed by one end of the columnar part and the surface of a disk part on one end side of the beam part, a first sealing part and a second sealing part that respectively form a circular sealed part by contacting a first object are provided, and on a second surface that is formed by the other end of the columnar part and the surface of a disk part on the other end side of the beam part, a third sealing part and a fourth sealing part that respectively form a circular sealed part by contacting a second object are provided;

the first sealing part is formed as a protruded part, and the second sealing part is formed by deformation of the disk part on one end side of the beam part when the protruded first sealing part is pressed by the first object; and

the third sealing part is formed as a protruded part, and the fourth sealing part is formed by deformation of the disk part on the other end side of the beam part when the protruded third sealing part is pressed by the second object.

According to the metal gasket of the present invention, due to the provision of the first sealing part, the second sealing part, the third sealing part and the fourth sealing part, reliable and excellent sealing performance can be exhibited. Further, a clamping force required for sealing can be reduced, whereby entire sealing performance or reliability of sealing performance can be improved.

### BRIEF DESCRIPTION OF THE DRAWINGS

FIG. 1 is a schematic plan view of the metal gasket according to a first embodiment of the present invention;

FIG. 2 is a schematic view of the metal gasket according to a first embodiment of the present invention, in which (a) is a side view, and (b) is a cross-sectional view taken along the line A-A in FIG. 1;

FIG. 3 is a schematic enlarged cross-sectional view of the essential parts for explaining the metal gasket according to a first embodiment of the present invention in the state before compression;

FIG. 4 is a schematic enlarged cross-sectional view of the essential parts for explaining the metal gasket according to a first embodiment of the present invention in the state after compression;

FIG. 5 is a schematic view of the metal gasket according to a second embodiment of the present invention, in which (a) is a plan view, and (b) is a cross-sectional view taken along the line B-B;

FIG. 6 is a schematic view of the metal gasket according to a third embodiment of the present invention, in which (a) is a plan view, and (b) is a cross-sectional view taken along the line C-C;

FIG. 7 is a schematic view of the metal gasket according to a fourth embodiment of the present invention, in which (a) is a plan view, and (b) is a cross-sectional view taken along the line D-D;

FIG. 8 is a schematic view of the metal gasket according to a fifth embodiment of the present invention, in which (a) is a plan view, and (b) is a cross-sectional view taken along the line E-E;

FIG. 9 is a schematic enlarged view of the essential parts for explaining the metal gasket according to Example 1 of the present invention, in which (a) is a cross-sectional view before compression, and (b) is a cross-sectional view after compression;

FIG. 10 is a schematic enlarged view of the essential parts for explaining the metal gasket according to Example 2 of the present invention, in which (a) is a cross-sectional view in the state before compression and (b) is a cross-sectional view in the state after compression;

FIG. 11 is a schematic enlarged view of the essential parts for explaining the metal gasket according to Example 3 of the present invention, in which (a) is a cross-sectional view in the state before compression and (b) is a cross-sectional view in the state after compression;

FIG. 12 is a schematic enlarged view of the essential parts for explaining the metal gasket according to Example 4 of the present invention, in which (a) is a cross-sectional view in the state before compression and (b) is a cross-sectional view in the state after compression; and

FIG. 13 is a schematic enlarged view of the essential parts for explaining the metal gasket according to Example 5 of the present invention, in which (a) is a cross-sectional view in the state before compression and (b) is a cross-sectional view in the state after compression.

### MODE FOR CARRYING OUT THE INVENTION

### First Embodiment

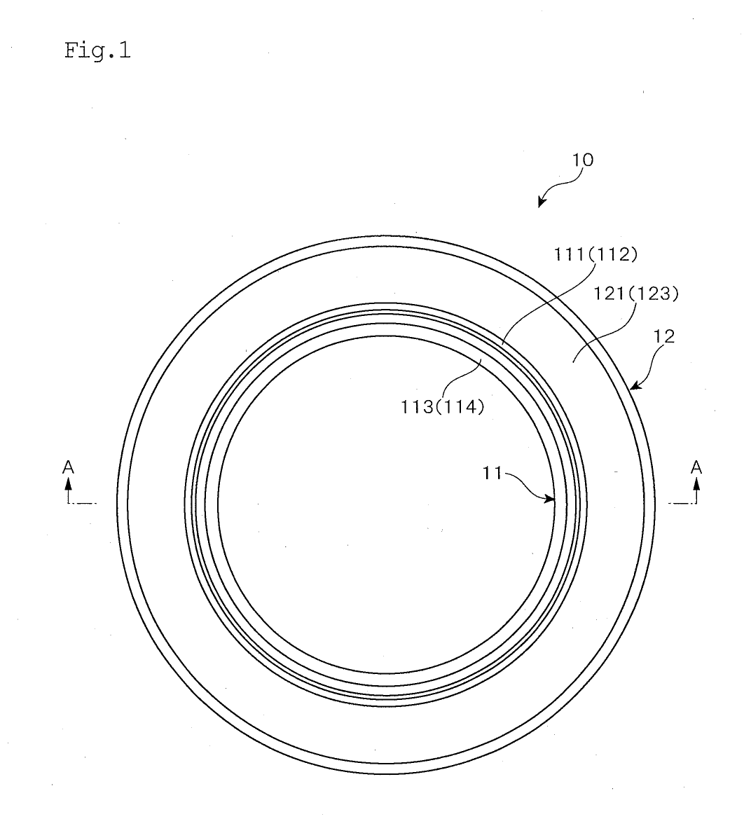

FIG. 1 is a schematic plan view of the metal gasket according to a first embodiment of the present invention.

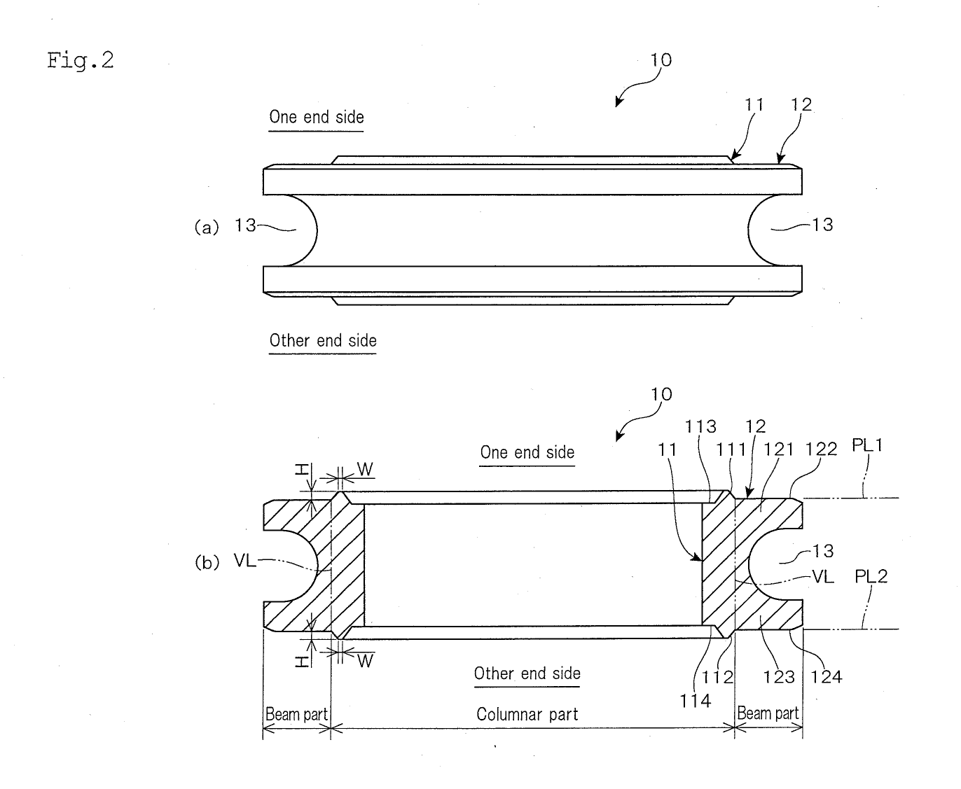

FIG. 2 is a schematic view of the metal gasket according to a first embodiment of the present invention, in which (a) is a side view, and (b) is a cross-sectional view taken along the line A-A in FIG. 1.

In FIGS. 1 and 2, a metal gasket 10 of this embodiment is provided with a columnar part 11 that is formed almost in a cylindrical form, a beam 12 that extends in a radial direction over the entire outer peripheral surface VL of this columnar part 11, and a circumferential groove 13 formed in the middle of the peripheral surface of the beam part 12.

As will be explained later, the columnar part 11 and the beam part 12 mentioned above are formed deformably.

Due to the formation of the circumferential groove 13, in the beam part 12, a disk part 121 on one end side (hereinafter referred to as the “one-end-side disk part 121) and a disk part 123 on the other side (hereinafter referred to as the “other-end-side disk part 123”) are formed. That is, the one-end-side disk part 121 extends, from the one end side of the columnar part 11, in a radial direction over the entire perimeter in a cantilever form. The other-end-side disk part 123 extends, from the other end side of the columnar part 11, in a radial direction over the entire perimeter in a cantilever form.

The cross sectional shape of the circumferential groove 13 is substantially a shape that is formed by dividing an ellipsoid into equal parts. The circumferential groove 13 of this embodiment has a configuration that it does not reach the outer peripheral surface VL of the columnar part 11.

The columnar part 11 and the beam part 12 are connected. In this state, as shown in FIG. 2(b), the outer peripheral surface VL of the columnar part 11 is a virtual outer peripheral surface. The outer part of the outer peripheral surface VL is the beam part 12, and the inner part of the outer peripheral surface VL is the columnar part 11.

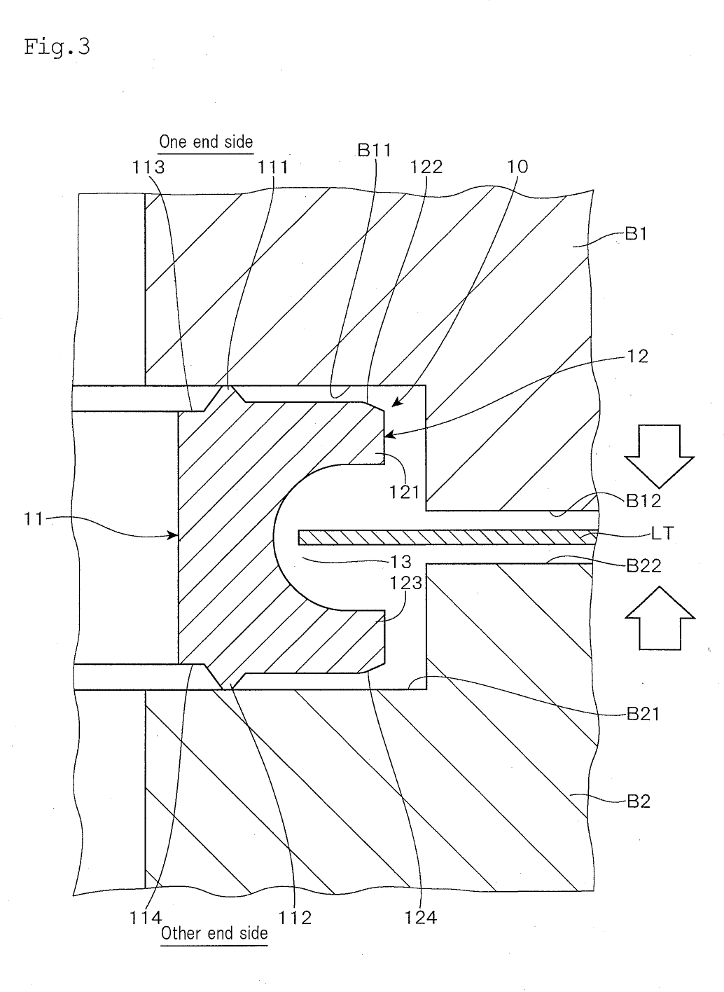

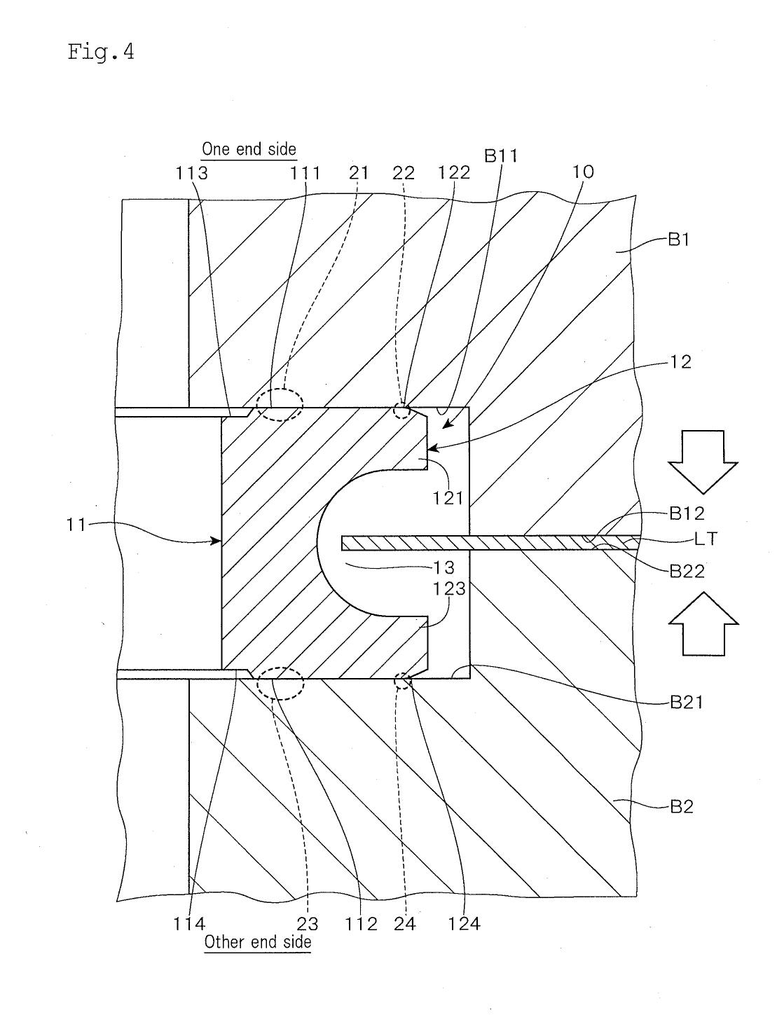

In the metal gasket 10, on one end of the columnar part 11 and a first surface PL1 formed by the surface of the one-end-side disk part 121 of the beam part 12, a first sealing part 111 and a second sealing part 122 that respectively form a circular sealed part (that is, a first sealed part 21 and a second sealed part 22) by contacting a first object B1 (see FIGS. 3 and 4) are provided.

Further, in the metal gasket 10, on the second surface PL2 that is formed by the other end of the columnar part 11 and the surface of the other-end-side disk part 123 of the beam part 12, a third sealing part 112 and a fourth sealing part 124 that respectively form a circular sealed part (that is, a third sealed part 23 and a fourth sealed part 24) by contacting a second object B2 (see FIGS. 3 and 4) are provided.

The first sealing part 111 is formed as a protruded part, and as will be mentioned later, the second sealing part 122 is formed by deformation of the one-end-side disk part 121 of the beam part 12 when the protruded first sealing part 111 is pressed by the first object B1.

The third sealing part 112 is formed as a protruded part, and as will be mentioned later, the fourth sealing part 124 is formed by deformation of the other-side-disk part 123 of the beam part 12 when the protruded third sealing part 112 is pressed by the second object B2.

Here, the “protruded” means a ring-like convex shape.

It is preferred that the protruded first sealing part 111 and the protruded third sealing part 112 be respectively formed on the end of the one end side and outside of the columnar part 11 and on the end of the other end side and outside of the columnar part 11 in a shape having a mountain-like cross section in a radial direction. It suffices that the width W (see FIG. 2(b)) of the apex of the mountain-like cross section be shorter than the height H of the mountain-like cross section.

Due to such a configuration, since the apex of the cross section of the mountain shape has a ring-like flat surface having a width W, when pressed by the first object B1 and the second object B2, the objects contact on this flat surface. Accordingly, no abnormal concentrated load is generated, and an almost uniform surface pressure distribution is obtained, whereby excellent sealing performance can be exhibited. In addition, when pressed by the first object B1 and the second object B2, the protruded first sealing part 111 and the protruded third sealing part 112 deform in the direction of compression. If the width W of the apex of the mountain-like cross section is shorter than the height H of the mountain shape, due to a small contact area, a clamping force required for sealing can be reduced.

Here, the height H of the mountain-like cross section shape means a height from the end surface of the columnar part 11. The end surfaces of the columnar part 11 serve as the first surface PL1 and the second surface PL2, respectively.

It is further preferred that the width W of the apex of the mountain-like cross-section be formed shorter than ⅔ of the height H of the mountain shape.

Due to such a configuration, when pressed by the first object B1 and the second object B2, the contact area of the protruded first sealing part 111 and the protruded third sealing part 112 can be further reduced, whereby a clamping force required for sealing can be further reduced.

In the meantime, the width W of the apex of the mountain-like cross section is normally long enough to prohibit occurrence of leakage even when particles are caught.

In this embodiment, a first concave part 113 and a second concave part 114 are respectively formed on the end of the one end side and inside of the columnar part 11 and the end of the other end side and inside of the columnar part 11. That is, the inner slope of the first sealing part 111 is extended, and the first concave part 113 is formed at a position nearer to the other end side than the first surface PL1. Further, the inner slope of the third sealing part 112 is extended, and the second concave part 114 is formed at a position nearer to the one end side than the second surface PL2.

Due to such a configuration, when pressed by the first object B1 and the second object B2, the surfaces of the first concave part 113 and the second concave part 114 do not contact the first object B1 and the second object B2. As a result, a clamping force required for sealing can be reduced.

It is preferred that the first sealing part 111 and the second sealing part 122 be formed almost concentrically, and is also preferred that the third sealing part 112 and the fourth sealing part 124 be formed almost concentrically.

Due to such a configuration, when the protruded first sealing part 111 is pressed by the first object B1, the amount of deformation of the one-end-side disk part 121 of the beam part 12 can be allowed to be almost the same in the circumferential direction, and the shape of the second sealing part 122 formed by deformation can be stabilized, whereby an almost uniform surface pressure distribution in a circumferential direction can be obtained in the second sealing part 122, leading to excellent sealing performance.

Similarly, when the protruded third sealing part 112 is pressed by the second object B2, the amount of deformation of the other-end-side disk part 123 of the beam part 12 can be allowed to be almost the same in the circumferential direction, and the shape of the fourth sealing part 124 formed by deformation can be stabilized, whereby an almost uniform surface pressure distribution in a circumferential direction can be obtained in the fourth sealing part 124, leading to excellent sealing performance.

In the meantime, the end of the one-end-side disk part 121 on the one end side and the end of the other-end-side disk part 123 on the other side are normally subjected to chamfering.

Further, it is preferred that the metal gasket 10 have a configuration that the air-tightness of a first sealed part 21 (see FIG. 4) formed by the first sealing part 111 and the first object B1 is higher than the air-tightness of a second sealed part 22 formed by the second sealing part 122 and the first object B1.

Further, it is preferred that the metal gasket 10 have a configuration that the air-tightness of a third sealed part 23 (see FIG. 4) formed by the third sealing part 112 and the second object B2 is higher than the air-tightness of a fourth sealed part 24 formed by the fourth sealing part 124 and the second object B2.

Due to such a configuration, by the first sealing part 111 and the third sealing part 112, reliable and excellent sealing performance can be exhibited, whereby a clamping force required for sealing can be reduced. Further, due to complementary sealing of the second sealing part 122 and the fourth sealing part 124, entire sealing performance or reliability of sealing can be improved. In addition, by contact of the first sealing part 111 and the second sealing part 122 with the first object B1, and by contact of the third sealing part 112 and the fourth sealing part 124 with the second object B2, the metal gasket 10 in the sealed state is stabilized, and reliability of sealing relative to variations in pressure, vibration or the like can be improved.

Meanwhile, in this embodiment, the metal gasket is configured such that the air-tightness of the first sealed part 21 is higher than the air-tightness of the second sealed part 22, and such that air-tightness of the third sealed part 23 is higher than the air-tightness of the fourth sealed part 24. The configuration is, however, not limited thereto.

For example, the metal gasket may be configured such that the first sealed part 21 has air-tightness that is almost equal to or lower than the air-tightness of the second sealed part 22, or the metal gasket may be configured such that the air-tightness of the third sealed part 23 is almost equal to or lower than the air-tightness of the fourth sealed part 24.

That is, the metal gasket 10 of this embodiment is normally used in a clean room and has the first sealing part 111 and the second sealing part 122, and the third sealing part 112 and the fourth sealing part 124. Accordingly, although not shown, for example, as compared with a metal gasket that only has the first sealing part 111 and the third sealing part 112, the risk of insufficient sealing due to caught-in of particles can be reduced by about ½. In this respect, reliability of sealing can be improved.

Further, it is preferred that the second sealing part 112 and the fourth sealing part 124 be overlapped with the circumferential groove 13 formed in the beam part 12 in the axial direction of the beam part 12. That is, in the metal gasket 10, the one-end-side disk part 121 has the second sealing part 122 that contacts the first object B1 by deformation, and the other-end-side disk part 123 has the fourth sealing part 124 that contacts the second object B2 by deformation.

Due to such a configuration, the second sealing part 122 and the fourth sealing part 124 may be formed without allowing the structure to be complicated.

In the metal gasket 10, normally, a metal material such as a stainless steel and Inconel, or those obtained by plating or depositing a soft metal such as nickel on these surfaces, are used.

Further, if the metal gasket 10 is used in a semiconductor industry, a single material of an austenite-based stainless steel such as SUS316L having excellent corrosion resistance or a vacuum double-dissolved material thereof or a vacuum triple-dissolved material thereof (a material that is dissolved/refined in vacuum twice to three times in order to reduce the amount of various chemical components that cause contamination) is preferable.

The metal gasket 10 can be formed by subjecting a metal round bar or a metal tube to cutting or a known mechanical processing (processing for removing a material) such as plain turning, milling, grinding or knurling. Further, it can be formed also by a method such as die forging in which a material is not removed at all.

The metal gasket 10 having the configuration mentioned above is used after being compressed by disposing between a pair of objects. The state of the use or the like will be explained with reference to the drawings.

FIG. 3 is a schematic enlarged cross-sectional view of the essential parts for explaining the metal gasket according to a first embodiment of the present invention in the state before compression.

FIG. 4 is a schematic enlarged cross-sectional view of the essential parts for explaining the metal gasket according to a first embodiment of the present invention in the state after compression.

As shown in FIG. 3, the metal gasket 10 is disposed between the first object B1 and the second object B2.

The first object B1 has a first abutting surface B11 having a recessed part for accommodating the metal gasket 10 and a second abutting surface B12 that abuts the retainer LT.

The second object B2 has a first abutting surface B21 having a recessed part for accommodating the metal gasket 10 and a second abutting surface B22 that abuts the retainer LT.

The retainer LT is disposed between the second abutting surface B12 of the first object B1 and the second abutting surface B22 of the second object B2, and is inserted into a space between the one-end-side disk part 121 of the metal gasket 10 and the other-end-side disk part 123 of the metal gasket 10, thereby to fix the metal gasket 10 temporarily.

As for the metal gasket 10 disposed between the first object B1 and the second object B2, the first sealing part 111 abuts the first abutting surface B11, and the third, sealing part 112 abuts the first abutting surface B21.

Further, in the state shown in FIG. 3, by further bringing the first object B1 and the second object B2 closer, in the metal gasket 10, the first sealing part 111 and the third sealing part 112 are started to be crushed by pressing.

Subsequently, as shown in FIG. 4, when the first object B1 abuts the second object B2 through the retainer LT, the first sealing part 111 and the third sealing part 112 are crushed and deformed.

In this state, by contact of the first sealing part 111 and the first object B1, the first sealed part 21 is formed. Due to pressing of the protruded first sealing part 111 by the first object B1, the outer peripheral part of the one-end-side disk part 121 of the beam part 12 is deformed in the direction of the first object B1, thereby forming the second sealing part 122 that contacts the first object B1. As a result, a part where the second sealing part 122 and the first object B1 contacts becomes the second sealed part 22.

Similarly, by contact of the third sealing part 112 and the second object B2, the third sealed part 23 is formed. Further, due to pressing of the protruded third sealing part 112 by the second object B2, the outer peripheral part of the other-end-side disk part 123 of the beam part 12 is deformed in the direction of the second object B2, thereby forming the fourth sealing part 124 that contacts the second object B2. As a result, a part where the fourth sealing part 124 contacts the second object B2 becomes the fourth sealed part 24.

That is, as mentioned above, in the metal gasket 10, an almost uniform surface pressure distribution can be obtained in the first sealing part 111 and the third sealing part 112, whereby excellent sealing performance can be exhibited. Further, due to a reduction in contact area, a clamping force required for sealing can be reduced.

Further, the metal gasket 10 is configured such that the air-tightness of the first sealed part 21 becomes higher than the air-tightness of the second sealed part 22, and that the air-tightness of the third sealed part 23 becomes higher than the air-tightness of the fourth sealed part 24. Accordingly, by the first sealing part 111 and the third sealing part 112, reliable and excellent sealing performance can be exhibited, and a clamping force required for sealing can be reduced. Further, due to complementary sealing of the second sealing part 122 and the fourth sealing part 124, entire sealing performance and reliability of sealing can be improved.

As mentioned hereinabove, according to the metal gasket 10 of this embodiment, not only entire sealing performance or reliability of sealing can be improved, but also a clamping force required for sealing can be reduced.

### Second Embodiment

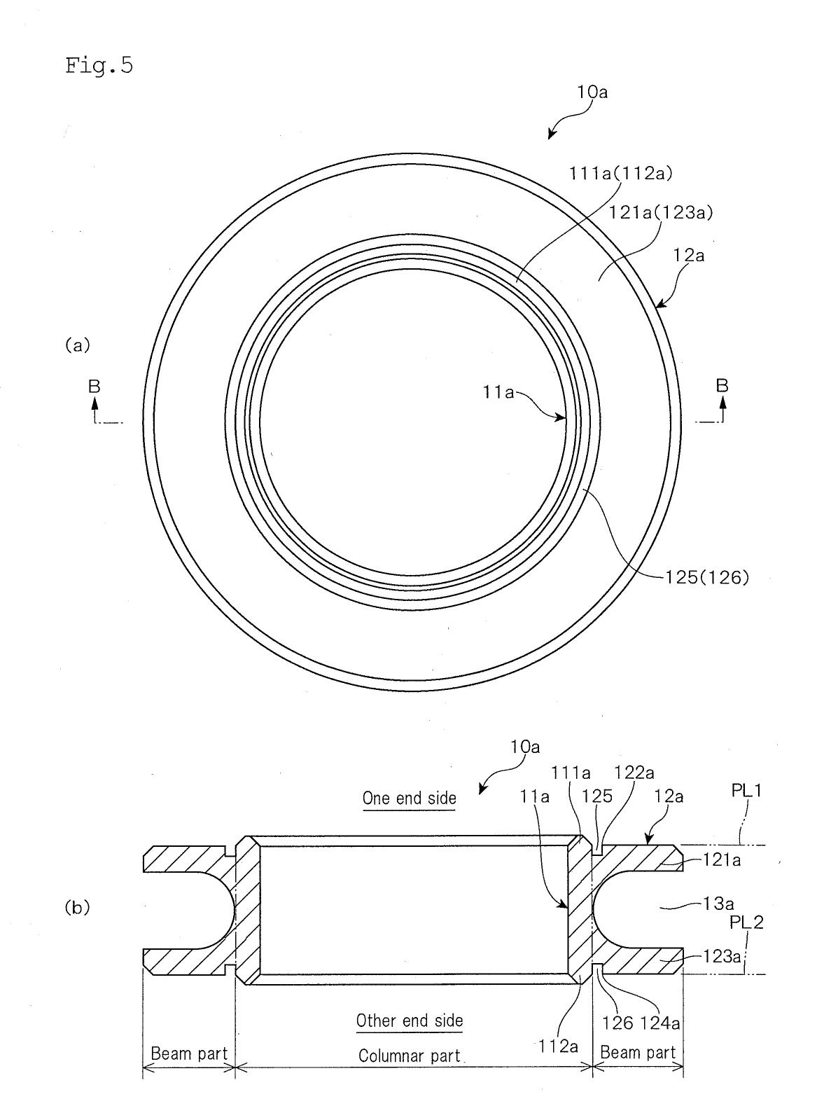

FIG. 5 is a schematic view of the metal gasket according to a second embodiment of the present invention, in which (a) is a plan view, and (b) is a cross-sectional view taken along the line B-B.

In FIG. 5, a metal gasket 10a of this embodiment differs from the metal gasket 10 of the first embodiment mentioned above in that the deepest part of the circumferential groove 13a formed in the beam part 12 is almost positioned in the outer peripheral surface (VL) of a columnar part 11a, and a first recessed part 125 and a second recessed part 126 are formed in the one-end-side disk part 121a and the other-end-side disk part 123a of the beam part 12a, respectively. Meanwhile, other configurations of this embodiment are almost the same as those of the metal gasket 10.

Therefore, in FIG. 5, the same constituting elements as those in FIGS. 1 and 2 are indicated by the same referential numerals and a detailed explanation is omitted.

The columnar part 11a differs from the columnar part 11 of the first embodiment in that it does not have parts corresponding to the first recessed part 113 and the second recessed part 114 and hence has a thickness smaller by an amount that corresponds to the depths of the first recessed part 113 and the second recessed part 114. In this columnar part 11a, a first sealing part 111a having an almost similar shape as that of the first sealing part 111 is formed on the one end side, and a third sealing part 112a having an almost similar shape as that of the third sealing part 112 is formed on the other end side.

Further, in the beam part 12a, on an inner edge part of the surface in the one end side of a one-end-side disk part 121a, a first recessed part 125 having an almost rectangular cross section is formed as a ring groove. Further, on an inner edge part of the surface in the other end side of the other-end-side disk part 123a, a second recessed part 126 having an almost rectangular cross section is formed as a ring groove.

In the metal gasket 10a, on the first surface PL1, a first sealing part 111a and a second sealing part 122a that respectively form a circular sealed part by contacting the first object B1 are provided.

Further, in the metal gasket 10a, on the second surface PL2, a third sealing part 112a and a fourth sealing part 124a that respectively form a circular sealed part by contacting the second object B2 are provided.

Here, the second sealing part 122a is formed in a part that is the surface in the one end side of the one-end-side disk part 121a and in the vicinity of the first recessed part 125. The fourth sealing part 124a is formed in a part that is the surface in the other end side of the other-end-side disk part 123a and in the vicinity of the second recessed part 126.

Further, the first sealing part 111a and the second sealing part 122a are formed almost concentrically, and the third sealing part 112a and the fourth sealing part 124a are formed almost concentrically.

As almost in the case of the first embodiment, in the metal gasket 10a having the above-mentioned configuration, an almost uniform surface pressure distribution can be obtained in the first sealing part 111a and the third sealing part 112a, and the metal gasket can exhibit excellent sealing performance. In addition, by reducing the contact area, a clamping force required for sealing can be reduced.

Further, the metal gasket 10a is configured to allow the air-tightness in the first sealed part 21 to be higher than the air-tightness in the second sealed part 22, and is configured to allow the air-tightness in the third sealed part 23 to be higher than the air-tightness in the fourth sealed part 24. Accordingly, by the first sealing part 111a and the third sealing part 112a, reliable and excellent sealing performance can be exhibited, and a clamping force required for sealing can be reduced. Further, due to complementary sealing of the second sealing part 122a and the fourth sealing part 124a, and other features, entire sealing performance or reliability of sealing can be improved.

As explained hereinabove, according to the metal gasket 10a of this embodiment, in an almost same manner as in the first embodiment, entire sealing performance or reliability of sealing can be improved, and a clamping force required for sealing can be reduced.

### Third Embodiment

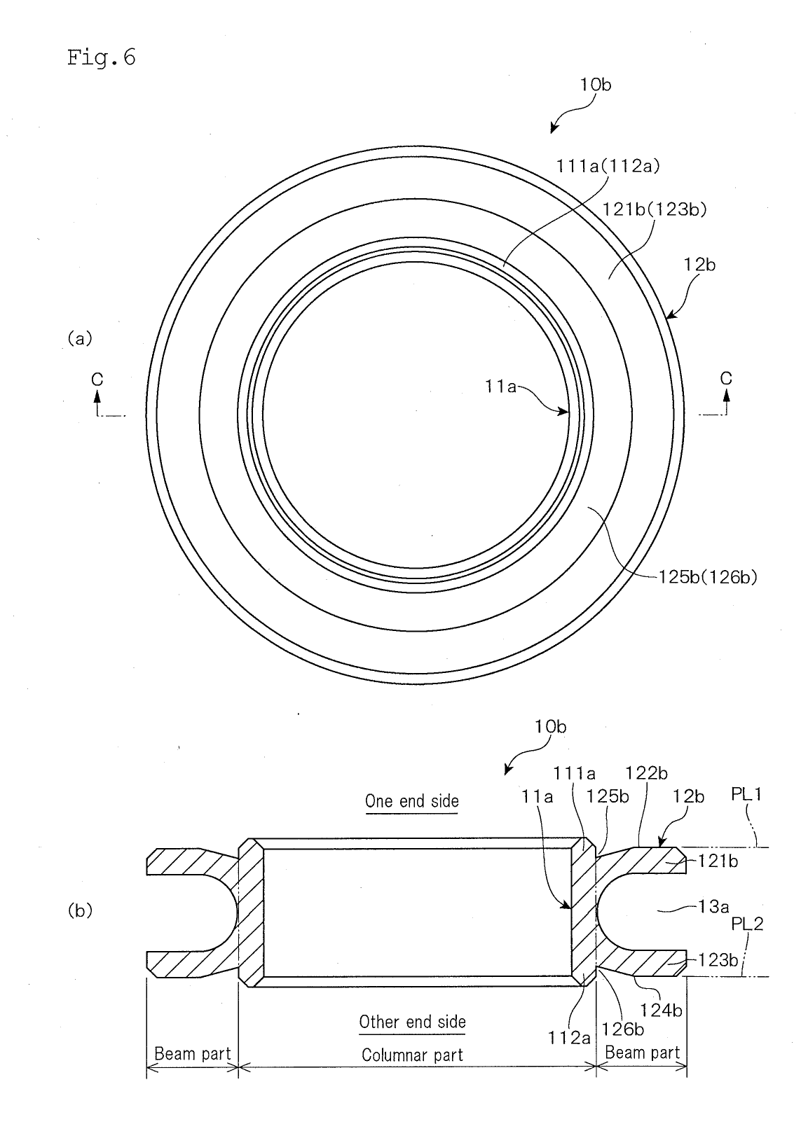

FIG. 6 is a schematic view of the metal gasket according to a third embodiment of the present invention, in which (a) is a plan view, and (b) is a cross-sectional view taken along the line C-C.

In FIG. 6, a metal gasket 10b of this embodiment differs from the metal gasket 10a of the second embodiment in that a first recessed part 125b and a second recessed part 126b each having an almost triangular cross section are formed instead of the first recessed part 125 and the second recessed part 126. Here, other configurations of this embodiment are almost the same as those of the metal gasket 10a.

Therefore, in FIG. 6, the same constituting elements as those in FIG. 5 are indicated by the same referential numerals and a detailed explanation is omitted.

In the beam part 12b, on an inner edge part of the surface in the one end side of the one-end-side disk part 121b, a first recessed part 125b having an almost right-angled rectangular cross section is formed as a ring groove. Further, on an inner edge part of the surface in the other end side of the other-end-side disk part 123b, a second recessed part 126b having an almost right-angled rectangular cross section is formed as a ring groove.

In the metal gasket 10b, on the first surface PL1, a first sealing part 111a and a second sealing part 122b that respectively form a circular sealed part by contacting the first object B1 are provided.

Further, in the metal gasket 10b, on the second surface PL2, a third sealing part 112a and a fourth sealing part 124b that respectively form a circular sealed part by contacting the second object B2 are provided.

Meanwhile, the second sealing part 122b is formed in a part that is the surface of one end side of the one-end-side disk part 121b and in the vicinity of the inclined surface of the first recessed part 125b. The fourth sealing part 124b is formed in a part that is the surface of the other end side of the other-end-side disk part 123b and in the vicinity of the inclined surface of the second recessed part 126b.

Further, the first sealing part 111a and the second sealing part 122b are formed almost concentrically, and the third sealing part 112a and the fourth sealing part 124b are formed almost concentrically.

As almost in the case of the second embodiment, in the metal gasket 10b having the above-mentioned configuration, an almost uniform surface pressure distribution can be obtained in the first sealing part 111a and the third sealing part 112a, and hence the metal gasket can exhibit excellent sealing performance. In addition, by reducing the contact area, a clamping force required for sealing can be reduced.

Further, the metal gasket 10b is configured to allow the air-tightness in the first sealed part 21 to be higher than the air-tightness in the second sealed part 22, and is configured to allow the air-tightness in the third sealed part 23 to be higher than the air-tightness in the fourth sealed part 24. Accordingly, by the first sealing part 111a and the third sealing part 112a, reliable and excellent sealing performance can be exhibited, and a clamping force required for sealing can be reduced. Further, due to complementary sealing of the second sealing part 122b and the fourth sealing part 124b, and other features, entire sealing performance or reliability of sealing can be improved.

As explained hereinabove, according to the metal gasket 10b of this embodiment, in an almost same manner as in the second embodiment, entire sealing performance or reliability of sealing can be improved, and a clamping force required for sealing can be reduced.

### Fourth Embodiment

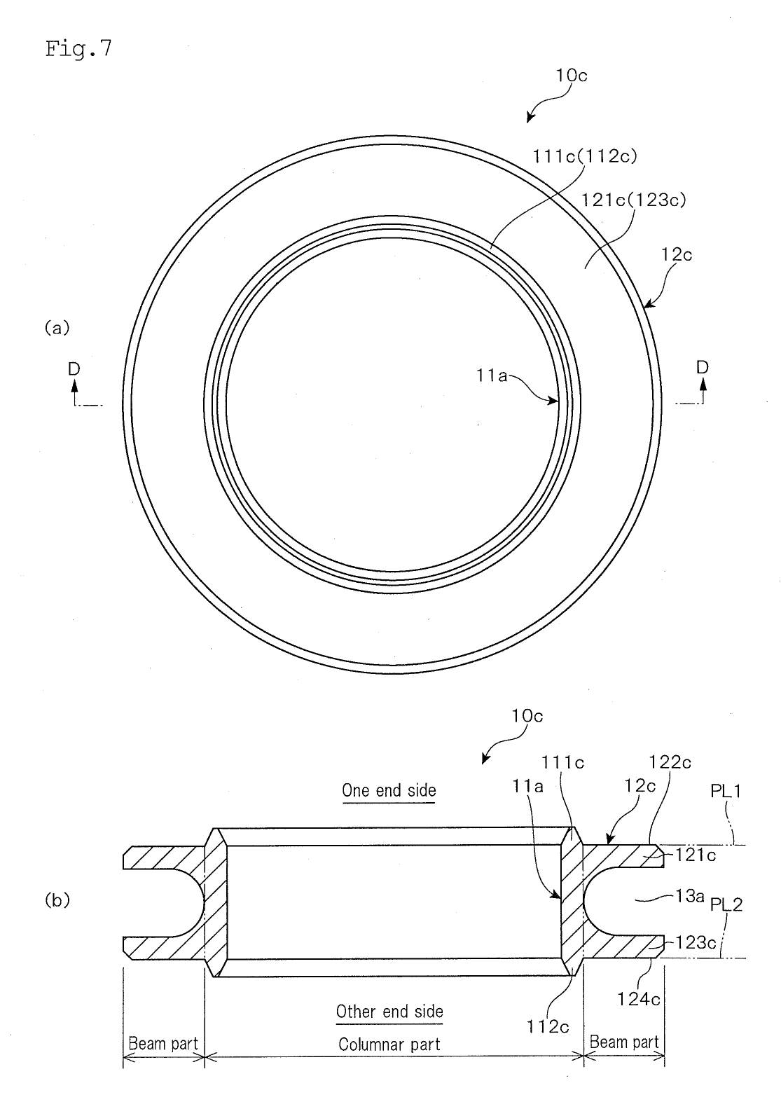

FIG. 7 is a schematic view of the metal gasket according to a fourth embodiment of the present invention, in which (a) is a plan view, and (b) is a cross-sectional view taken along the line D-D.

In FIG. 7, a metal gasket 10c of this embodiment differs from the metal gasket 10a of the second embodiment in that a first sealing part 111c and a third sealing part 112c each having a large protrusion are formed, and that the first recessed part 125 and the second recessed part 126 are not formed. Meanwhile, other configurations of this embodiment are almost the same as those of the metal gasket 10a.

Therefore, in FIG. 7, the same constituting elements as those in FIG. 5 are indicated by the same referential numerals and a detailed explanation is omitted.

In this embodiment, the first recessed part 125 and the second recessed part 126 are not formed, and the amounts of protrusion of the first sealing part 111c and the third sealing part 112c are adjusted. That is, as compared with the first sealing part 111a and the third sealing part 112a, the first sealing part 111c and the third sealing part 112c are respectively formed such that the protruded amount is almost twice as large. As a result, the angle of the slope is acute.

In the metal gasket 10c, on the first surface PL1, a first sealing part 111c and a second sealing part 122c that respectively form a circular sealed part by contacting the first object B1 are provided.

Further, in the metal gasket 10c, on the second surface PL2, a third sealing part 112c and a fourth sealing part 124c that respectively form a circular sealed part by contacting the second object B2 are provided.

Here, the second sealing part 122c is formed in a part that is the surface of one end side of the one-end-side disk part 121c and in the vicinity of the edge part on the outside (the edge part inside of the chamfered part), and the fourth sealing part 124c is formed in a part that is the surface of the other side of the other-end-side disk part 123c and in the vicinity of the edge part on the outside (the edge part inside of the chamfered part).

Further, the first sealing part 111c and the second sealing part 122c are formed almost concentrically, and the third sealing part 112c and the fourth sealing part 124c are formed almost concentrically.

As almost in the case of the second embodiment, in the metal gasket 10c having the above-mentioned configuration, an almost uniform surface pressure distribution can be obtained in the first sealing part 111c and the third sealing part 112c, and hence the metal gasket can exhibit excellent sealing performance. In addition, by reducing the contact area, a clamping force required for sealing can be reduced.

Further, the metal gasket 10c is configured to allow the air-tightness in the first sealed part 21 to be higher than the air-tightness in the second sealed part 22, and is configured to allow the air-tightness in the third sealed part 23 to be higher than the air-tightness in the fourth sealed part 24. Accordingly, by the first sealing part 111c and the third sealing part 112c, reliable and excellent sealing performance can be exhibited, and a clamping force required for sealing can be reduced. Further, due to complementary sealing of the second sealing part 122c and the fourth sealing part 124c, and other features, entire sealing performance or reliability of sealing can be improved.

As explained hereinabove, according to the metal gasket 10c of this embodiment, in an almost same manner as in the second embodiment, entire sealing performance or reliability of sealing can be improved, and a clamping force required for sealing can be reduced.

Meanwhile, the deepest part of the circumferential groove 13a formed in the beam part 12c can be remote from the outer peripheral surface (VL) of the columnar part 11a as in the case of the first embodiment, according to the material, or the like.

### Fifth Embodiment

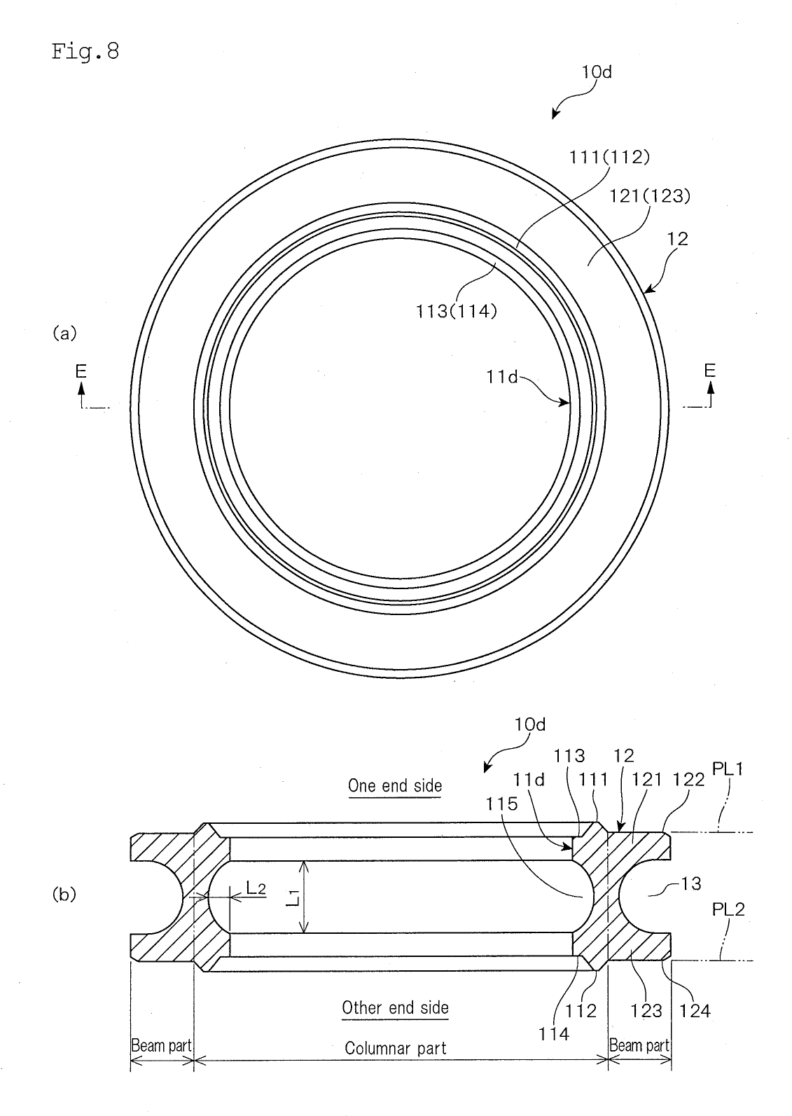

FIG. 8 is a schematic view of the metal gasket according to a fifth embodiment of the present invention, in which (a) is a plan view, and (b) is a cross-sectional view taken along the line E-E.

In FIG. 8, a metal gasket 10d of this embodiment differs from the metal gasket 10 of the first embodiment in that an inner circumferential groove 115 is formed on the inner peripheral surface of a columnar part 11d. Other configurations of this embodiment are almost the same as those of the metal gasket 10.

Therefore, in FIG. 8, the same constituting elements as those in FIGS. 1 and 2 are indicated by the same referential numerals and a detailed explanation is omitted.

In the columnar part 11d, in almost the middle of the inner peripheral surface (in almost the middle in the axial direction of the columnar part 11d), the inner circumferential groove 115 having a curved surface is formed.

In this inner circumferential groove 115, the dimension in the axial direction of the columnar part 11d is L₁ and the depth is L₂. In this embodiment, the dimension L₁ is almost the same as the dimension of the axial direction of an opening of the circumferential groove 13. The dimension L₂ is a depth that almost reaches a virtual line (not shown) connecting the apexes of the cross sections of the mountain shapes of the first sealing part 111 and the third sealing part 112. However, the dimensions L₁ and L₂ are not limited thereto, and can be appropriately set.

In the metal gasket 10d having the above-mentioned configuration, when used, if the first object B1 and the second object B2 abut through the retainer LT, the first sealing part 111 and the third sealing part 112 are crushed and deformed (see FIG. 4).

In this state, in an almost same manner as in the first embodiment, by contact of the first sealing part 111 and the first object B1, the first sealed part 21 is formed. Further, by pressing of the protruded first sealing part 111 by the first object B1, the outer peripheral part of the one-end-side disk part 121 of the beam part 12 is deformed in the direction of the first object B1 to form the second sealing part 122 that contacts the first object B1. As a result, a part where the second sealing part 122 contacts the first object B1 forms a second sealed part 22.

Further, by contact of the third sealing part 112 and the second object B2, the third sealed part 23 is formed. Further, by pressing of the protruded third sealing part 112 by the second object B2, the outer peripheral part of the other-end-side disk part 123 of the beam part 12 is deformed in the direction of the second object B2 to form a fourth sealing part 124 that contacts the second object B2. As a result, a part where the fourth sealing part 124 contacts the second object B2 becomes a fourth sealed part 24.

Here, in the metal gasket 10d, since the inner circumferential groove 115 is formed on the inner peripheral surface of the columnar part 11d, when the protruded first sealing part 111 is pressed by the first object B1, the one-end-side disk part 121 of the beam part 12 is more largely deformed in the one end side than in the first embodiment, whereby sealing performance or the like of the second sealing part 122 can be improved.

Further, when the protruded third sealing part 112 is pressed by the second object B2, the other-end-side disk part 123 of the beam part 12 is more largely deformed in the other end side than in the first embodiment, whereby sealing performance or the like of the fourth sealing part 124 can be improved.

As almost in the case of the first embodiment, in the metal gasket 10d having the above-mentioned configuration, an almost uniform surface pressure distribution can be obtained in the first sealing part 111 and the third sealing part 112, and the metal gasket can exhibit excellent sealing performance. In addition, by reducing the contact area, a clamping force required for sealing can be reduced.

Further, the metal gasket 10d is configured to allow the air-tightness in the first sealed part 21 to be higher than the air-tightness in the second sealed part 22, and is configured to allow the air-tightness in the third sealed part 23 to be higher than the air-tightness in the fourth sealed part 24. Accordingly, by the first sealing part 111 and the third sealing part 112, reliable and excellent sealing performance can be exhibited, and a clamping force required for sealing can be reduced. Further, due to complementary sealing of the second sealing part 122 and the fourth sealing part 124, and other features, entire sealing performance or reliability of sealing can be improved.

Further, since the one-end-side disk part 121 of the beam part 12 and the other-end-side disk part 123 of the beam part 12 are largely deformed as compared with the first embodiment, the sealing performance of the second sealing part 122 and the fourth sealing part 124, or the like can be improved.

As explained hereinabove, according to the metal gasket 10d of this embodiment, in an almost same manner as in the first embodiment, entire sealing performance or reliability of sealing can be improved, and a clamping force required for sealing can be reduced.

### EXAMPLE 1

As Example 1, the metal gasket 10 of the above-mentioned first embodiment was subjected to a stress analysis by using the finite element method. Next, an explanation will be made on this Example 1 with reference to the drawings.

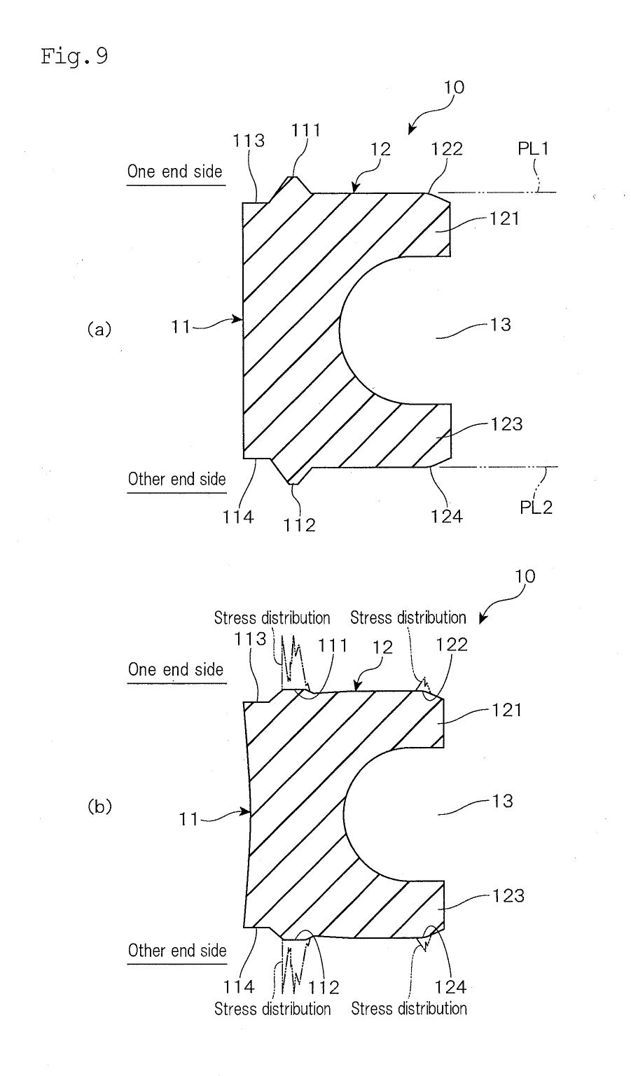

FIG. 9 is a schematic enlarged view of the essential parts for explaining the metal gasket according to Example 1 of the present invention, in which (a) is a cross-sectional view before compression, and (b) is a cross-sectional view after compression.

The shape of the metal gasket 10 that was subjected to a stress analysis is almost similar to the shape shown in FIG. 9(a). As the physical property value of the material of the metal gasket 10, the physical property value of the SUS316L was used.

Further, as shown in FIG. 4, the metal gasket 10 is sealed in the state where it is sandwiched between a first abutment surface B11 of the first object B1 and a first abutment surface B21 of the second object B2.

Regarding the results of the stress analysis, as shown in FIG. 9(b), the metal gasket 10 was deformed. Parts protruding sharply from the first sealing part 111, the second sealing part 122, the third sealing part 112 and the fourth sealing part 124 each indicate a stress distribution, indicating that a larger amount of a protruded part means generation of a larger stress.

By this stress analysis, it has been revealed that, in the metal gasket 10, the air-tightness of the first sealed part 21 formed by the first sealing part 111 and the first object B1 is higher than the air-tightness of the second sealed part 22 formed by the second sealing part 122 and the first object B1. Further, it has been revealed that the air-tightness of the third sealed part 23 formed by the third sealing part 112 and the second object B2 is higher than the air-tightness of the fourth sealed part 24 formed by the fourth sealing part 124 and the second object B2.

Further, it has been revealed that the maximum surface pressure, i.e. the maximum surface pressure at the first sealing part 111 and the third sealing part 112, can be 2200 MPa, for example, and entire sealing performance or reliability of sealing can be improved, and a clamping force required for sealing can be reduced.

### EXAMPLE 2

As Example 2, the metal gasket 10a of the above-mentioned second embodiment was subjected to a stress analysis by using the finite element method. An explanation will be made on this Example 2 with reference to the drawings.

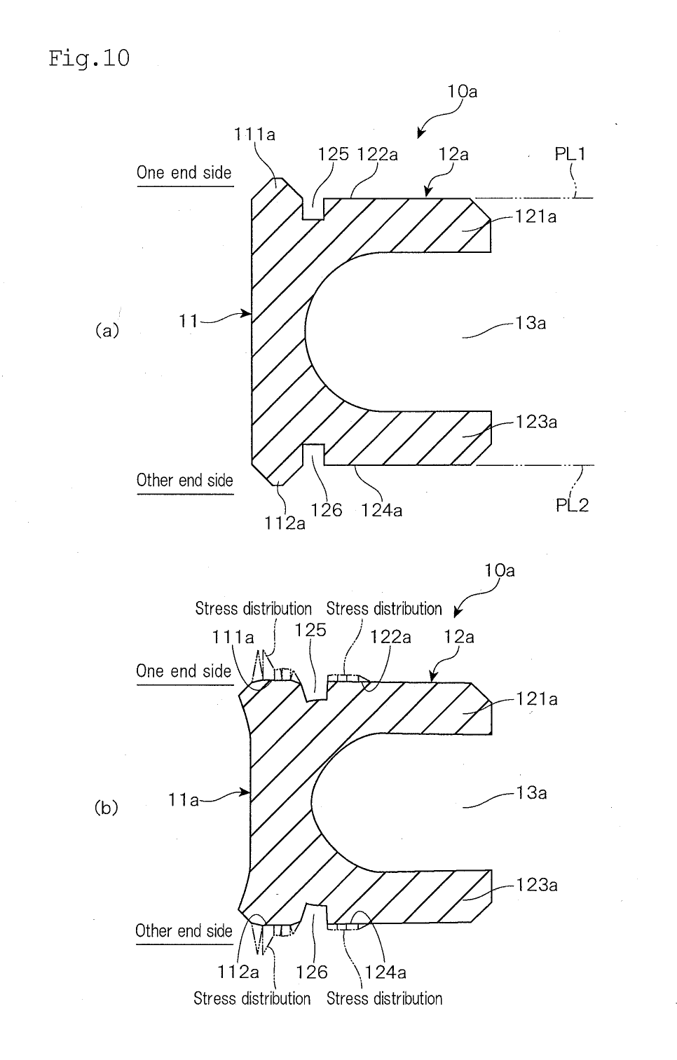

FIG. 10 is a schematic enlarged view of the essential parts for explaining the metal gasket according to Example 2 of the present invention, in which (a) is a cross-sectional view in the state before compression and (b) is a cross-sectional view in the state after compression.

The shape of the metal gasket 10a subjected to the stress analysis is almost the same as the shape shown in FIG. 10(a). Other conditions are almost the same as those in Example 1.

Regarding the results of the stress analysis, as shown in FIG. 10(b), the metal gasket 10a was deformed. Parts protruding sharply from the first sealing part 111a, the second sealing part 122a, the third sealing part 112a and the fourth sealing part 124a each indicate a stress distribution. A larger amount of a protruded part means generation of a larger stress.

By this stress analysis, it has been revealed that, in the metal gasket 10a, the air-tightness of the first sealed part 21 formed by the first sealing part 111a and the first object B1 is higher than the air-tightness of the second sealed part 22 formed by the second sealing part 122a and the first object B1. Further, it has been revealed that the air-tightness of the third sealed part 23 formed by the third sealing part 112a and the second object B2 is higher than the air-tightness of the fourth sealed part 24 formed by the fourth sealing part 124a and the second object B2.

Further, it has been revealed that the maximum surface pressure, i.e. the maximum surface pressure at the first sealing part 111a and the third sealing part 112a can be 1680 MPa, for example, and entire sealing performance or reliability of sealing can be improved, and a clamping force required for sealing can be reduced.

### EXAMPLE 3

As Example 3, the metal gasket 10b of the above-mentioned third embodiment was subjected to a stress analysis by using the finite element method. An explanation will be made on this Example 3 with reference to the drawings.

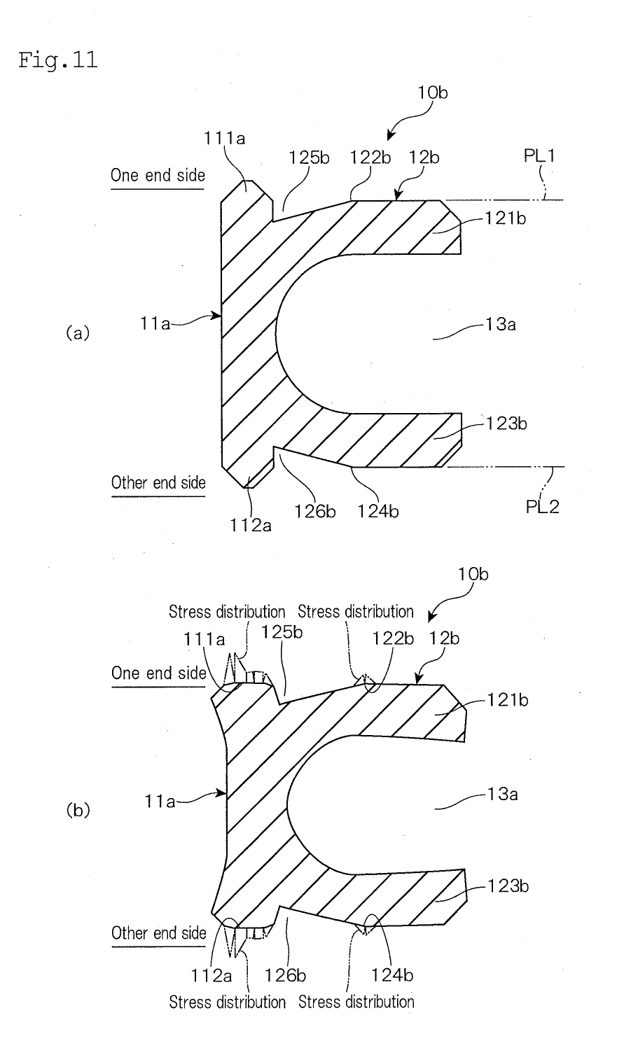

FIG. 11 is a schematic enlarged view of the essential parts for explaining the metal gasket according to Example 3 of the present invention, in which (a) is a cross-sectional view in the state before compression and (b) is a cross-sectional view in the state after compression.

The shape of the metal gasket 10b subjected to the stress analysis is almost the same as the shape shown in FIG. 11(a). Other conditions are almost the same as those in Example 1.

Regarding the results of the stress analysis, as shown in FIG. 11(b), the metal gasket 10b was deformed. Parts protruding sharply from the first sealing part 111a, the second sealing part 122b, the third sealing part 112a and the fourth sealing part 124b each indicate a stress distribution. A larger amount of a protruded part means generation of a larger stress.

By this stress analysis, it has been revealed that, in the metal gasket 10b, the air-tightness of the first sealed part 21 formed by the first sealing part 111a and the first object B1 is higher than the air-tightness of the second sealed part 22 formed by the second sealing part 122b and the first object B1. Further, it has been revealed that the air-tightness of the third sealed part 23 formed by the third sealing part 112a and the second object B2 is higher than the air-tightness of the fourth sealed part 24 formed by the fourth sealing part 124b and the second object B2.

Further, it has been revealed that the maximum surface pressure, i.e. the maximum surface pressure at the first sealing part 111a and the third sealing part 112a can be 1520 MPa, for example, and entire sealing performance or reliability of sealing can be improved, and a clamping force required for sealing can be reduced.

### EXAMPLE 4

As Example 4, the metal gasket 10c of the above-mentioned fourth embodiment was subjected to a stress analysis by using the finite element method. An explanation will be made on this Example 4 with reference to the drawings.

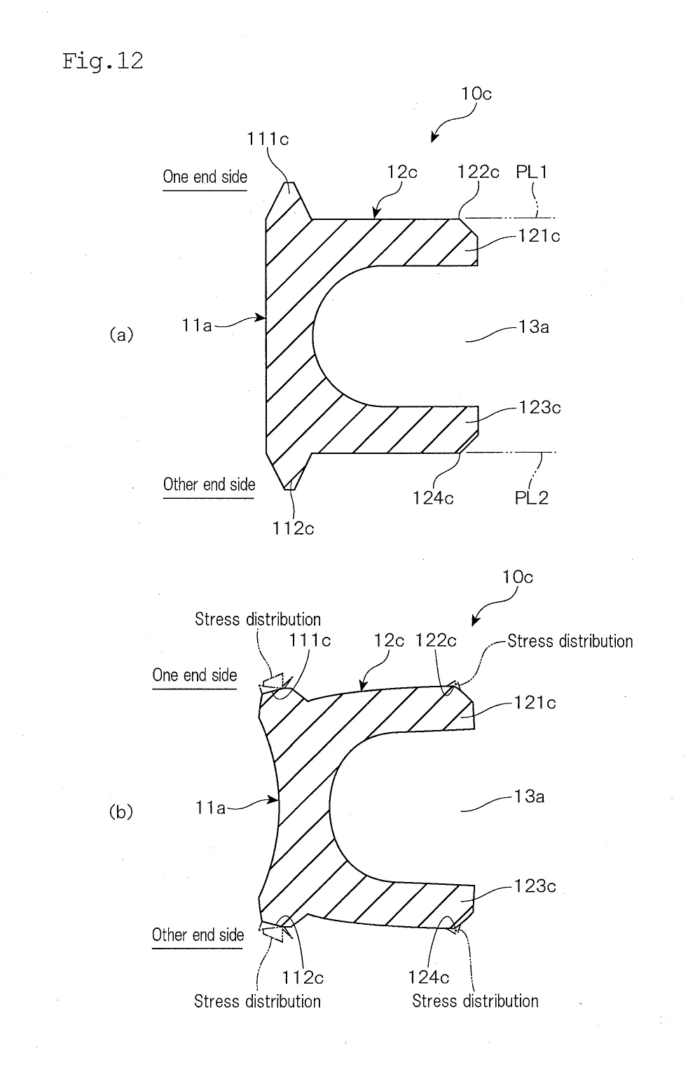

FIG. 12 is a schematic enlarged view of the essential parts for explaining the metal gasket according to Example 4 of the present invention, in which (a) is a cross-sectional view in the state before compression and (b) is a cross-sectional view in the state after compression.

The shape of the metal gasket 10c subjected to the stress analysis is almost the same as the shape shown in FIG. 12(a). Other conditions are almost the same as those in Example 1.

Regarding the results of the stress analysis, as shown in FIG. 12(b), the metal gasket 10c was deformed. Parts protruding sharply from the first sealing part 111c, the second sealing part 122c, the third sealing part 112c and the fourth sealing part 124c each indicate a stress distribution. A larger amount of a protruded part means generation of a larger stress.

By this stress analysis, it has been revealed that, in the metal gasket 10c, the air-tightness of the first sealed part 21 formed by the first sealing part 111c and the first object B1 is higher than the air-tightness of the second sealed part 22 formed by the second sealing part 122c and the first object B1. Further, it has been revealed that the air-tightness of the third sealed part 23 formed by the third sealing part 112c and the second object B2 is higher than the air-tightness of the fourth sealed part 24 formed by the fourth sealing part 124c and the second object B2.

Further, it has been revealed that the maximum surface pressure, i.e. the maximum surface pressure at the first sealing part 111c and the third sealing part 112c can be 920 MPa, for example, and entire sealing performance or reliability of sealing can be improved, and a clamping force required for sealing can be reduced.

### EXAMPLE 5

As Example 5, the metal gasket 10d of the above-mentioned fifth embodiment was subjected to a stress analysis by using the finite element method. An explanation will be made on this Example 5 with reference to the drawings.

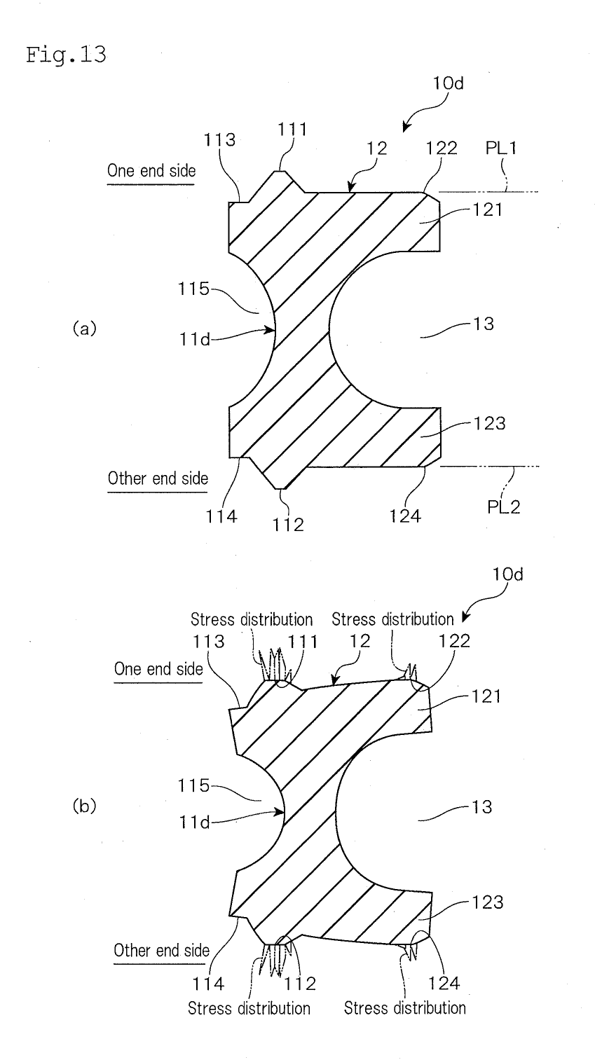

FIG. 13 is a schematic enlarged view of the essential parts for explaining the metal gasket according to Example 5 of the present invention, in which (a) is a cross-sectional view in the state before compression and (b) is a cross-sectional view in the state after compression.

The shape of the metal gasket 10d subjected to the stress analysis is almost the same as the shape shown in FIG. 13(a). Other conditions are almost the same as those in Example 1.

Regarding the results of the stress analysis, as shown in FIG. 13(b), the metal gasket 10d was deformed. Parts protruding sharply from the first sealing part 111, the second sealing part 122, the third sealing part 112 and the fourth sealing part 124 each indicate a stress distribution. A larger amount of a protruded part means generation of a larger stress.

By this stress analysis, it has been revealed that, in the metal gasket 10d, the air-tightness of the first sealed part 21 formed by the first sealing part 111 and the first object B1 is higher than the air-tightness of the second sealed part 22 formed by the second sealing part 122 and the first object B1. Further, it has been revealed that the air-tightness of the third sealed part 23 formed by the third sealing part 112 and the second object B2 is higher than the air-tightness of the fourth sealed part 24 formed by the fourth sealing part 124 and the second object B2.

Further, it has been revealed that the maximum surface pressure, i.e. the maximum surface pressure at the first sealing part 111 and the third sealing part 112, can be 1367 MPa, for example, and entire sealing performance or reliability of sealing can be improved, and a clamping force required for sealing can be reduced.

Hereinabove, the metal gasket of the present invention was explained with reference to preferred embodiments, or the like. The metal gasket according to the present invention is not limited to the above-mentioned embodiments, and various modifications are possible within the scope of the invention.

For example, in the above-mentioned embodiments, the cross-sectional shape of the circumferential groove 12 is substantially a shape formed by dividing an ellipse into equal parts. The shape is not limited thereto. For example, although not shown, the cross-sectional shape of the circumferential groove may be rectangular, triangle or substantially a shape formed by dividing an oval shape into equal parts.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in this specification and the Japanese application specification claiming priority under the Paris Convention are incorporated herein by reference in its entirety.

1. A metal gasket comprising:
a columnar part formed in a cylindrical shape;
a beam part that extends in a radial direction over the entire outer peripheral surface of the columnar part; and
a circumferential groove formed in the middle of a peripheral surface of the beam part,
wherein the columnar part and the beam part are formed deformably,
wherein, on a first surface that is formed by one end of the columnar part and the surface of a disk part on one end side of the beam part, a first sealing part and a second sealing part that respectively form a circular sealed part by contacting a first object are provided, and on a second surface that is formed by the other end of the columnar part and the surface of a disk part on the other end side of the beam part, a third sealing part and a fourth sealing part that respectively form a circular sealed part by contacting a second object are provided,
wherein the first sealing part is formed as a protruded part, and the second sealing part is formed by deformation of the disk part on one end side of the beam part when the protruded first sealing part is pressed by the first object, and
wherein the third sealing part is formed as a protruded part, and the fourth sealing part is formed by deformation of the disk part on the other end side of the beam part when the protruded third sealing part is pressed by the second object.

2. The metal gasket according to claim 1, wherein the air-tightness of the first sealed part formed by the first sealing part and the first object is higher than the air-tightness of the second sealed part formed by the second sealing part and the first object and the air-tightness of the third sealed part formed by the third sealing part and the second object is higher than the air-tightness of the fourth sealed part formed by the fourth sealing part and the second object.

3. The metal gasket according to claim 1, wherein the first sealing part and the second sealing part are formed concentrically, and the third sealing part and the fourth sealing part are formed concentrically.

4. The metal gasket according to claim 1, wherein the protruded first sealing part and the protruded third sealing part are respectively formed on an end on the one end side of the columnar part and an end on the other end side of the columnar part in a shape having a mountain-like cross section in the radial direction, and the width of the apex of the mountain-like cross section is formed shorter than the height of the mountain-like cross section.

5. The metal gasket according to claim 4, wherein the width of the apex of the mountain-like cross section is formed shorter than ⅔ of the height of the mountain shape.

6. The metal gasket according to claim 1, wherein the deepest part of the circumferential groove formed in the beam part is positioned on the outer peripheral surface (VL) of the columnar part.

7. The metal gasket according to claim 1, wherein a ring-like groove is formed in each of the disk part on the one end side of the beam part and the disk part on the other end side of the beam part.

8. The metal gasket according to claim 1, wherein the second sealing part and the fourth sealing part overlap with the circumferential groove formed in the beam part in the axial direction of the beam part.

9. The metal gasket according to claim 1, wherein an inner circumferential groove is formed on the inner peripheral surface of the columnar part.
